(19) United States
(12) Patent Application Publication
(10) Pub. No.: US 2004/0249063 A1
(43) Pub. Date: Dec. 9, 2004

(54) Deposition of copper layers on substrates

(76) Inventors: Hans-Josef Sterzel, Dannstadt-Schauernheim (DE); Lars Wittenbecher, Mannheim (DE); Patrick Deck, Mannheim (DE)

Correspondence Address: Herbert B. Keil, KEIL & WEINKAUF, 1350 Connecticut Ave., N.W., Washington, DC, 20036, US

(21) Appl. No.: 10/859,085

(22) Filed: Jun. 3, 2004

(30) Foreign Application Priority Data
Jun. 3, 2003 (DE) 10325243.6

(51) Int. Cl. C08L 75/00

(52) U.S. Cl. 524/591

(57) ABSTRACT

Copper layers are deposited on substrates by bringing the substrate into contact with a solution of copper (II) formate and alkoxyalkylamines of formula I R¹—O—(CH₂)ₙ—CHR²—NH₂, where R¹ is methyl or ethyl, R² is hydrogen or methyl and n is 1, 2, 3 or 4, at from 120 to 200° C. and from 0.1 to 5 bar.

The present invention relates to the deposition of copper layers on substrates.

The currentless deposition of metallic copper from aqueous Cu²⁺ baths with formaldehyde as a reducing agent is known from Copper—Fundamental Mechanisms for Micro-electronic Applications, John Wiley & Sons, 2000, pages 301-302, paragraph 9.5.3. Such baths usually also contain a number of assistant such as complexing agents, inhibitors and possibly leveling agents. Before the actual deposition, it is necessary here to carry out nucleation by means of platinum metals, which are applied by way of another bath.

WO-A-97/33713 furthermore discloses the application of metallic copper by using dispersions which contain metal particles having particle sizes from 10 to 100 nm. Such dispersions, also referred to as inks, additionally contain dispersants, such as polyvinylpyrrolidone, relatively long-chain alcohols, amines or acid amides. The disadvantage of this process is that the dispersants are necessarily relatively high molecular weight to high molecular weight and are incorporated into the metal layer, with the result that the quality of the layer is adversely affected. In any case, the dispersants have to be removed by an expensive procedure after the formation of the layer.

It is an object of the present invention to remedy the abovementioned disadvantages.

We have found that this object is achieved by a novel and improved process for depositing copper layers on substrates, wherein the substrate is brought into contact with a compound comprising copper (II) formate and alkoxyalkylamines of the formula I R¹—O—(CH₂)ₙ—CHR²—NH₂, where R¹ is methyl or ethyl and R² is hydrogen or methyl and n is 1, 2, 3 or 4, at from 80 to 200° C. and from 0.1 to 5 bar.

The process of the invention can be carried out as follows:

The compound comprising copper (II) formate and alkoxyalkylamines of the formula I R¹—O—(CH₂)ₙ—CHR²—NH₂, where R¹ is methyl or ethyl, R² is hydrogen or methyl and n is 1, 2, 3 or 4, and, if required, an inert solvent can be brought into contact with the substrate at from 80 to 200° C., preferably from 80 to 150° C., particularly preferably from 100 to 150° C., and from 0.1 to 5 bar, preferably from 0.5 to 2 bar, particularly preferably atmospheric pressure.

The substrate can be brought into contact with the compound comprising copper (II) formate and alkoxyalkylamines I and, if required, an inert solvent by all known application techniques, for example immersion, spraying, spray-drying, imprinting, spin-coating, infiltration, painting on, inscribing or printing. The substrate is as a rule preheated, but it can also be used cold and the treated substrates then heated.

The compounds comprising copper (II) formate and alkoxyalkylamines I may be present as compounds for reaction, complexes or dissolved mixtures.

Substrates to be coated over a large area can be infiltrated, for example, by printing techniques such as screen printing, letterpress printing, gravure printing, offset printing, pad printing or inkjet printing.

Rigid, sheet-like substrates, in particular wafers for microelectronics, can be coated by spin-coating and then heated.

Bulk material, fragments and milled material (e.g. powder) can be coated, for example, in heatable mixing drums. In a preferred embodiment, spray-dryers are used.

The powders thus obtained are suitable for the production of electrically conductive adhesive tapes or, for example, for filling plastics in order to make them antistatic, electrically conductive and/or impermeable to electromagnetic radiation.

By means of the novel process, it is possible, for example, to produce printed circuits in one step without photolithographic methods, to coat porous substrates in tantalum or ceramic capacitors in a single step with copper layers without washing steps, to contact optically active elements of high-resolution displays in a particularly advantageous manner, to provide flexible connections between microchips, batteries and other components on flexible films, which can be used in suitable geometric form also as transmitting and receiving aerials for electronic circuits.

Conductive porous material prepared according to the invention and having specific surface areas of from 0.01 to 10 m²/g can advantageously be used, for example, as electrodes in electrolysis cells or batteries.

Finally, it is also possible to process the compounds comprising copper (II) formate and alkoxyalkylamines I and an inert solvent directly to give very finely divided copper powder. It is advantageous for this purpose to spray the low-viscosity solutions of copper complexes in a spray-dryer, the liquid feed being kept below the decomposition temperature (below about 90° C.) and the inert drying gas, for example nitrogen, from 10 to 100° C. above the decomposition temperature. It is possible in this way to prepare copper powders which are free of impurities and have particle sizes down to 1 nm. In order to prevent the agglomeration of such fine copper powders they are advantageously collected directly in a suitable liquid, such as amines, alcohols, ketones, hydrocarbons or mixtures thereof.

The preparation of the compounds comprising copper (II) formate and alkoxyalkylamines I and, if required, an inert solvent can be carried out by initially taking alkoxyalkylamine I or a mixture thereof under an inert gas atmosphere, e.g. nitrogen or argon, substantially free of CO₂ and introducing copper (II) formate, for example as the tetrahydrate. The temperature should as a rule not exceed 60 to 70° C.

By initially taking the stoichiometrically required 2 moles of alkoxyalkylamines I per mole of copper (II) formate, the greatest possible copper concentration and at the same time a frequently desirable high product viscosity are obtained.

If lower viscosities are desired for processing, inert solvents, for example ketones, such as acetone or methyl lethyl ketone or aromatics, such as toluene or xylenes, are added, or a superstoichiometric amount of alkoxyalkylamine I is used.

If the amount of water introduced through water of crystallization of the copper (II) formate presents problems for a particular application, it is likewise possible to use an excess, as a rule from 0.5 to 5 mol, preferably from 0.5 to 2 mol, of alkoxyalkylamine I and to remove, e.g. distill off the excess amine simultaneously with the water under reduced pressure at no higher than 60 to 70° C.

In order to improve the adhesion and the homogeneity of the copper on the surfaces to be coated, it may be advantageous to admix additives in small amounts of from 0.01 to 0.5, preferably from 0.02 to 0.1,% by weight to the compounds comprising copper (II) formate and alkoxyalkylamines I. Suitable additives are, for example, commercially available leveling agents such as polysiloxanes whose terminal groups are surrounded by polyether blocks, e.g. TEGO® Glide 432 from Degussa.

Suitable substrates are as a rule all materials, both electrically conductive and electrically poorly conductive or nonconductive materials, having a smooth or porous structure and surface, for example plastics, preferably heat-resistant polymers such as polybutylene terephthalate, polyamide 6, polyamide 6,6, polycarbonate, polysulfone, polyether sulfone, polyphenylene sulfide, glass, oxides, metals or ceramics. As a rule, the shape of these substrates may be as desired, for example plates, films, foams, spheres, hollow spheres, moldings in the form of stars, wagon wheels, cylinders, right parallelepipeds, rectangles, cones, honeycombs and bulk material, fragments and milled materials.

Suitable alkoxyalkylamines are those of the formula I R¹—O—(CH₂)ₙ—CHR²—NH₂, where R¹ is methyl or ethyl, R² is hydrogen or methyl and n is 1, 2, 3 or 4. Preferred alkoxyalkylamines I are those having boiling points under atmospheric pressure of from 8 to 150° C., particularly preferably CH₃—O—CH₂—CH₂—NH₂, CH₃—O—CH₂—CH(CH₃)—NH₂, CH₃—O—(CH₂)₂—CH₂—NH₂ and C₂H₅—O—(CH₂)₂—CH₂—NH₂.

### EXAMPLES

### Example 1

### Reaction of Copper (II) Formate with 2-methoxyethylamine

7.67 g (0.05 mol) of copper (II) formate tetrahydrate (Cu(HCOO)₂*4 H₂O) were introduced into 15 g (0.2 mol) of 2-methoxyethylamine at up to 50° C. under an argon atmosphere and stirred for 20 minutes, and thereafter the excess amine and the water of crystallization were removed under reduced pressure at up to 60° C. The resulting compound had a copper content of about 22% by weight.

### Example 2

### Reaction of Copper (II) Formate with 3-methoxypropylamine

The reaction was carried out analogously to example 1, except that 17.82 g (0.2 mol) of 3-methoxypropylamine were used instead of 2-methoxyethylamine. The resulting compound had a copper content of about 20% by weight.

For further processing, 0.05% by weight of the additive (a leveling agent) TEGO® Glide 432 was added to the compound.

### Example 3

### Reaction of Copper (II) Formate with 3-ethoxypropylamine

The reaction was carried out analogously to example 1, except that 20.64 g (0.2 mol) of 3-ethoxypropylamine were used instead of 2-methoxyethylamine. The resulting compound had a copper content of about 17% by weight.

### Example 4

Mixture of 2-methoxyethylamine and 3-methoxypropylamine The reaction was carried out analogously to example 1, except that a mixture of 7.51 g (0.1 mol) of 2-methoxyethylamine and 8.91 g (0.1 mol) of 3-methoxypropylamine was used.

### Example 5

### Deposition of Copper on a Glass Surface

2 ml of the compound prepared in example 2 were applied to a glass microscope slide and distributed, and said slide was heated to a final temperature of approx. 180° C. under an argon atmosphere in the course of 1 hour. The final temperature was maintained for about 10 minutes followed by cooling back to room temperature.

A readily adhering uniform copper layer which conducted the electric current well was obtained.

### Example 6

### Deposition of Copper onto the Polymer Films

The deposition was carried out analogously to example 5 onto the following polymer films: sulfonated polyether ether ketune (PEEK), polybutylene terephthalate, polyamide 6, polyamide 6,6 and polyether sulfone film. Uniform and readily conducting layers which adhered well were obtained.

### Example 7

### Deposition on Hollow Glass Spheres

10 g of hollow glass spheres (of diameter from 10 to 30 μm) were mixed under an argon atmosphere with 4.5 g of the mixture prepared in example 2 and dried at 180° C. and 400 mbar. Copper-coated hollow glass spheres which conducted the electric current well were not formed.

We claim:

1. A process for depositing copper layers on substrates, wherein the substrate is brought into contact with a compound comprising copper (II) formate and alkoxyalkylamines of the formula I R¹—O—(CH₂)ₙ—CHR²—NH₂, where R¹ is methyl or ethyl and R² is hydrogen or methyl and n is 1, 2, 3 or 4, at from 80 to 200° C. and from 0.1 to 5 bar.

2. The use of a compound comprising copper (II) formate and alkoxyalkylamines of the formula I R¹—O—(CH₂)ₙ—CHR²—NH₂, where R¹ is methyl or ethyl, R² is hydrogen or methyl and n is 1, 2, 3 or 4, for coating substrates.

3. The use of a compound consisting of copper (II) formate and alkoxyalkylamines of the formula I R¹—O—(CH₂)ₙ—CHR²—NH₂, where R¹ is methyl or ethyl, R² is hydrogen or methyl and n is 1, 2, 3 or 4, and, if required, an inert solvent for coating substrates.

4. A mixture comprising a compound of copper (II) formate and alkoxyalkylamines of the formula I R¹—O—(CH₂)ₙ—CHR²—NH₂, where R¹ is methyl or ethyl, R² is hydrogen or methyl and n is 1, 2, 3 or 4, for coating substrates.

5. A mixture consisting of a compound of copper (II) formate and alkoxyalkylamines of the formula I R¹—O—(CH₂)ₙ—CHR²—NH₂, where R¹ is methyl or ethyl, R² is hydrogen or methyl and n is 1, 2, 3 or 4, and, if required, an inert solvent for coating substrates.

6. A compound comprising copper (II) formate and alkoxyalkylamines as claimed in any of claims 1, 2, 3, 4 and 5, wherein said compound contains from 0.01 to 0.5% by weight of additives.

7. A process for the preparation of finely divided copper, wherein a compound comprising copper (i) formate and alkoxyalkylamines of the formula I R¹—O—(CH₂)ₙ—CHR²—NH₂, where R¹ is methyl or ethyl, R² is hydrogen or methyl and n is 1, 2, 3 or 4, in an inert solvent is spray-dried at from 80 to 200° C. and from 0.1 to 5 bar.
